(19) United States
(12) Patent Application Publication
(10) Pub. No.: US 2015/0310559 A1
(43) Pub. Date: Oct. 29, 2015

(54) System And Method To Adjust Eligibility For Health Plan Benefits

(71) Applicants: William Kaafarani, Dearborn Heights, MI (US); Mohamad Bazzi, Dearborn, MI (US)

(72) Inventors: William Kaafarani, Dearborn Heights, MI (US); Mohamad Bazzi, Dearborn, MI (US)

(21) Appl. No.: 14/263,039

(22) Filed: Apr. 28, 2014

(51) Int. Cl. G06Q 40/08; G06Q 50/22

(52) U.S. Cl. CPC G06Q 40/08; G06Q 50/22

(57) ABSTRACT

Changing eligibility for a plan benefit in a health plan includes transmitting an information request from a server computer system to a client computer of an enrollee, and determining via a processor of the server computer system predicted likelihood of misuse of a product delivered to the enrollee, responsive to data entered by the enrollee in satisfaction of the information request. The processor switches a flag setting based on the predicted likelihood, so as to adjust a record obligation of a third party payor under the health plan to pay for a product not yet delivered to the enrollee.

### TECHNICAL FIELD

The present disclosure relates generally to changing eligibility for a plan benefit of an enrollee in a health plan, and more particularly to computer implemented adjustment of a record obligation of a third party payor under a health plan to provide future plan benefits to the enrollee.

### BACKGROUND

Fraud, waste, abuse and other undesired practices have plagued the healthcare industry for decades. There are innumerable ways in which healthcare products, notably prescription drugs, can be misused. Dispensing to the wrong person, resale on the street, and paid-for-but-never-delivered products, are examples of misuse. Products are sometimes sold to a patient, paid for by a third party payor, then sold back to the dispensary at a discount for fraudulent sale again. Some forms of misuse are intentional, and criminal, while others can result from mere negligence. Product misuse, whether intentional or not, of course adds to the burden of excessive healthcare costs. In an attempt to control costs, regulations have been passed or are pending in various jurisdictions which attempt to rein-in dishonest, careless and wasteful practices. There remain various “leak paths” whereby healthcare products themselves and/or the related commercial transactions and money transfers can escape from tracking and regulatory oversight. Hence, fraud, waste, abuse and other undesired practices remain widespread. Recent regulatory changes and new legal frameworks can unfortunately be expected to create new opportunities for misuse within the complex ecosystem of manufacturers, distributors, dispensaries, healthcare providers, and patients.

Serialization of prescription medical products represents one attempt at increasing trackability and traceability of items through the stream of commerce, with overall goals of reducing healthcare costs and protecting patients. Track and trace policies and technologies now proposed are expected to have many beneficial effects on the supply and distribution side of prescription medical products and related commercial transactions. In other words, opportunities between the manufacturer and dispensary for actual product, or funds, to leak into the wrong hands, or into the garbage dump, are expected to decline. The capability of known strategies and technologies to improve the general state of affairs, however, will generally end at the location and point in time where a patient receives delivery of healthcare products.

The present disclosure is directed to one or more of the problems or shortcomings set forth above.

### SUMMARY

In one aspect, a method of changing eligibility for a plan benefit of an enrollee in a health plan includes receiving on a server computer system a notification of a transaction on an account of the enrollee, where a third party payor is obligated under the health plan to pay for a product delivered via the transaction. The method further includes transmitting an information request from the server computer system to a client device of the enrollee, and receiving on the server computer system data entered in satisfaction of the information request. The method further includes switching a flag setting via the processor, responsive to the data, and being determinative of a record obligation of the third party payor under the health plan to provide a plan benefit not yet delivered to the enrollee.

In another aspect, a system for benefits administration in a health plan includes a server computer having a processor, a computer readable memory coupled with the processor, and inputs and outputs for receiving and transmitting data between the server computer and a communications network. The computer readable memory stores a control algorithm, in code executable by the processor, for changing eligibility for future plan benefits of any one of a population of enrollees in the health plan. The server computer is configured to receive a notification transmitted over the communications network and being indicative of a transaction on an account of one of the enrollees, where a third party payor is obligated under the health plan to pay for a product delivered in the transaction. The server computer is further configured to transmit an information request over the communications network to a client device of the one of the enrollees, and to receive and store data entered in satisfaction of the information request. The server computer is still further configured, via execution of the code by the processor, to switch a flag setting determinative of a record obligation of the third party payor under the health plan to provide a plan benefit not yet delivered to the one of the enrollees, responsive to the determined value.

### BRIEF DESCRIPTION OF THE DRAWINGS

FIG. 1 is a system level diagram of a system for benefits administration in a health plan, according to one embodiment;

FIG. 2 is a system level diagram similar to FIG. 1 and illustrating additional details;

FIG. 3 is a diagrammatic view of messages displayed on client devices, according to one embodiment; and

FIG. 4 is a flowchart of example methodology according to one embodiment.

### DETAILED DESCRIPTION

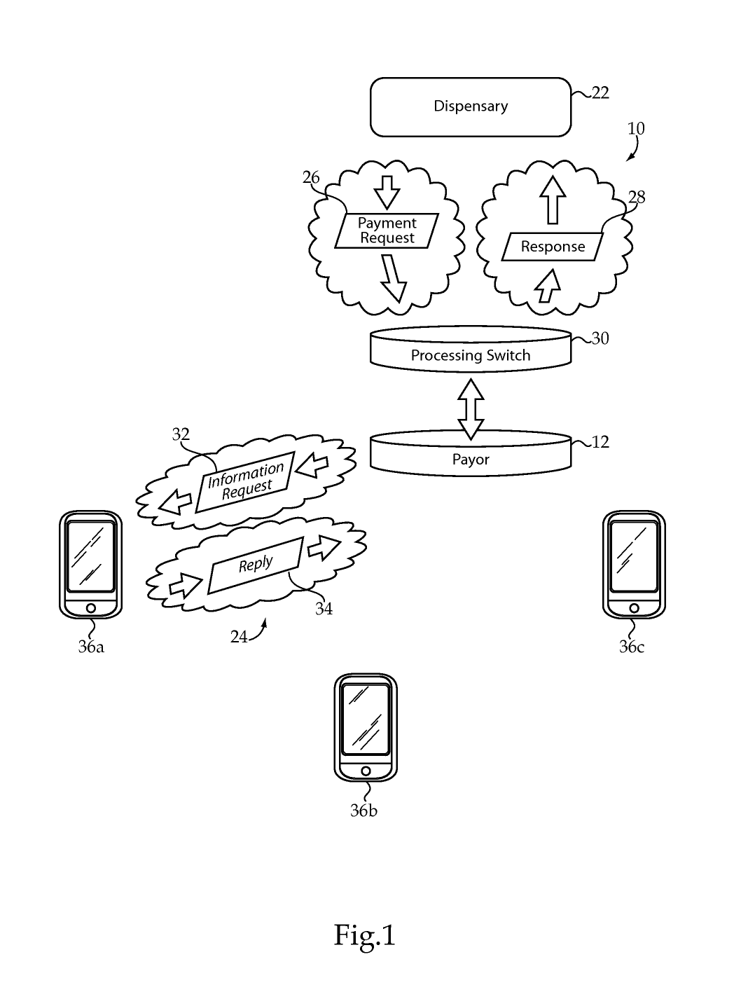

Referring to FIG. 1, there is shown a system 10 for benefits administration in a health plan. System 10 includes a server computer or server computer system 12, operated by or on behalf of a third party payor in the health plan. The third party payor may be a third party insurer in an employer sponsored health plan, but might also be a self-insured employer itself, or still another entity having contractual obligations to provide benefits to enrollees in a health plan. Computer 12 may be in bidirectional communication with a processing switch 30, itself a server computer system, which serves to transfer data between computer 12 and one or more provider computer systems. In a practical implementation strategy processing switch 30 can receive electronic insurance claims from a great many different provider computer systems, such as institutional or retail pharmacies, physician practices, or still others, and forward those claims to computer 12 where they are evaluated for payment. Processing switch 30 and computer 12 may, and typically will, be located remotely from one another.

Processing switch 30 may also transmit responses from computer 12 to any of the provider computer systems. In FIG. 1, a payment request 26 and a response 28 are shown transmitted over a communications network 24, such as the Internet, between a dispensary 22 and processing switch 30, which in turn communicates with computer 12. The payment request and response will typically be created and processed in a manner generally known in the art. The actual authorization to pay a claim will typically take place on computer 12. Where a claim for payment is embodied in request 26, computer 12 may evaluate the claim and transmit an authorization or denial embodied in response 28. It will thus be appreciated that a patient may be filling an original or refill prescription for a prescription medical product such as a medication at dispensary 22. Dispensary 22 may thus transmit request 26 to computer 12 via processing switch 30, and ultimately be authorized via response 28 to complete the transaction and deliver the product to the patient.

Also shown in FIG. 1 is an information request 32 and a reply 34 transmitted over the same communications network 24, or another suitable network, between computer 12 and a client device such as a computer 36a of one of a population of enrollees in the health plan. Additional client devices 36b and 36c are also shown in FIG. 1, associated with additional enrollees. All of the elements depicted in FIG. 1 could fairly be understood to be part of system 10, although in one practical implementation strategy system 10 is resident entirely upon or within computer 12. The terms “computer” and “computer system” are used interchangeably herein in reference to computer 12, as computer 12 be a single machine with a processor and a memory, albeit still fairly considered a system. Computer or computer system 12 might also include multiple processors and memories at different physical locations so as to perform functions distributively among multiple machines.

As noted above, computer 12 may communicate, for example by way of processing switch 30, with dispensary 22 and any of a variety of other dispensaries and other providers, for processing of electronic claims for payment. Those skilled in the art will be familiar with the nature of health plans where a third party payor is obligated by contract to provide certain benefits under the health plan to any of a population of enrollees. Notable among the benefits provided is at least partial payment, and typically full payment apart from a predefined or variable co-pay amount, for products and/or services delivered to enrollees from a healthcare provider, including a medication dispensary. As alluded to above many opportunities for fraud, waste, abuse and other undesired practices exist in the complex web of communications between and among participants and stakeholders in health plans. A practical application of the teachings of the present disclosure is reduction in fraud, waste and abuse, and improved overall efficiency in the delivery of certain healthcare products and services under a health plan. This practical application exploits the ability of computer implemented technology to autonomously or semi-autonomously interact with a patient enrollee in a health plan to increase their engagement and participation in the management of their own health. Moreover, the present disclosure is tailored for implementation within an existing computerized framework whereby products, such as original fills and refills for prescription medicine, are delivered to patients and paid for at least in part by third party payors. As will also be further apparent from the following description, interaction between the patient enrollee and the third party payor enables the enrollee to be evaluated, know the standards by which they are being evaluated, and qualify or disqualify themselves from receipt of future plan benefits by their own actions.

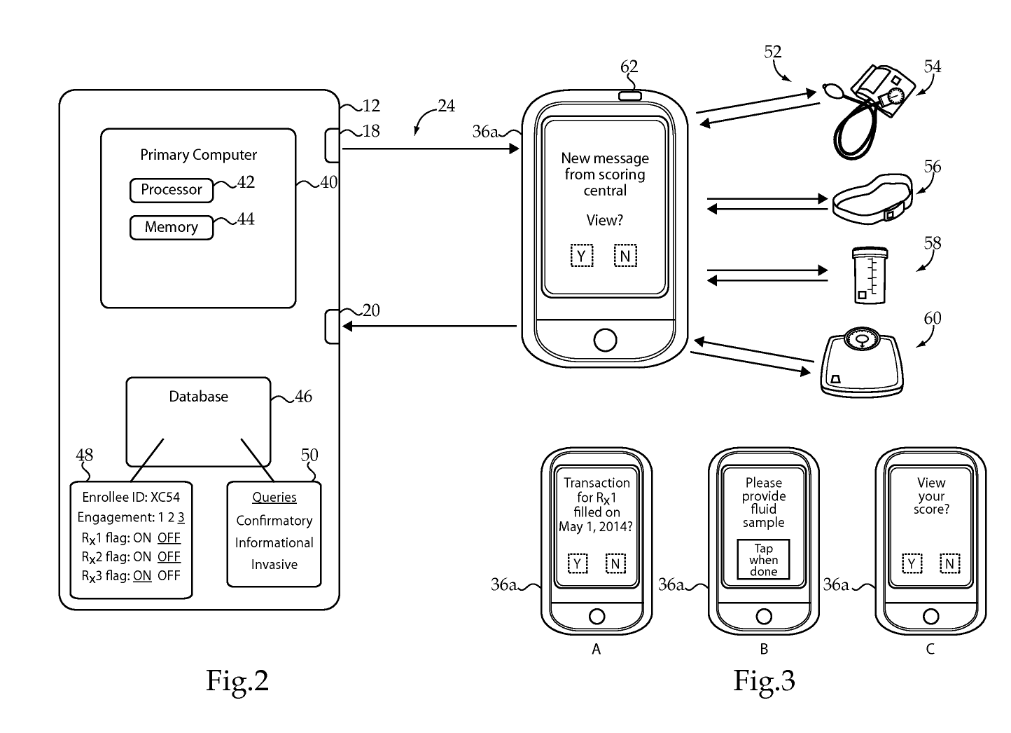

Referring also now to FIG. 2, there are shown additional details of system 10 by way of further diagrammatic illustration. Computer or computer system 12 may include a primary computer 40, having a processor 42 and a computer readable memory 44 coupled with processor 42. Primary computer 40 may also include one or more inputs 18 such as communication ports and one or more outputs 20, such as communication ports, for receiving and transmitting data between computer system 12 and communication network 24, ultimately for communicating with any one of the plurality of client devices 36a-c of each one of a population of enrollees in the health plan. The actual population of enrollees could include tens or hundreds of thousands of persons. Primary computer 40 may also be configured to access a database 46, which may be part of or directly connected to server computer 12 in one embodiment. Database 46 might also be a cloud-based database, or otherwise distributed amongst a plurality of computers so as to indirectly connect with computer 12. Computer readable memory 44, which includes any suitable type of volatile or non-volatile memory, stores a control algorithm, in code executable by processor 42, for changing eligibility for plan benefits of any one of the population of enrollees in the health plan.

It will be recalled that computer system 12 may receive payment request 26 from dispensary 22. In a practical implementation strategy, payment request 26 has the form of an electronically fillable pdf, a tiff file, or another electronic form, populated with such data as the account number or name of an enrollee in the health plan, a type and an amount of medication or another product to be delivered via dispensing and for which payment by the third party payor is sought, and potentially other information such as the prescribing physician, a time stamp, a date stamp. Such a payment request can serve as a notification, transmitted over a communications network, indicative of a transaction on the enrollee's account within the health plan, where the third party payor is obligated under the health plan to pay for a product delivered in the transaction. The product may in fact be delivered to the enrollee who is the account holder, but might instead be delivered to a person posing as the account holder, the consequences of which will be further apparent from the following description. The term “indicative of” is intended to mean in the present context that computer 12 is alerted to the initiation, or initiation and execution, of a commercial transaction for delivery of the product. Receipt of the payment request by computer 12 can therefore be understood as the notification, regardless of the content of the payment request itself. Another form of notification might be used instead, independent of the request for payment. Response 28 may be an electronic signal encoding an enrollee account number and “Yes” or “No” to the requested payment, but might also include more detailed information such as a reason for denial of a claim or a counter-request for more information and/or listing a copay amount.

Computer 12 may further be configured to transmit information request 32 over communications network 24 to a client device 36a of the one of the enrollees, as depicted in FIG. 1, and to receive and store on computer readable memory 44 data entered in satisfaction of the information request 32. As further discussed herein, information request 32 may have a variety of different forms, and could include an actual query of the enrollee or instead a notification to the enrollee to log into an account and enter data in response to a query viewable once logged in. In other words, the information request may itself be understood as a notification that information is requested, or it could be the actual request for information. Information request 32 might be a text message, an email, an automated phone call or still another communication form perceptible by the enrollee and capable of encoding information.

Computer 12 may further be configured, via execution of the code comprising the control algorithm, to determine a value indicative of predicted likelihood of misuse of the delivered product, responsive to the data. As further discussed herein, the determined value may be calculated on the basis of a health scoring strategy for each enrollee in the plan, but could also be calculated independently of scoring. The potential misuse of interest could be potential misuse by the enrollee whose account the transaction occurs upon, or someone else such as an imposter. The determined value may include a numeric value calculated by processor 42. The determined value could also include a proportional value corresponding to a predicted likelihood, say, 10% predicted likelihood, of misuse of the delivered product. In other embodiments, the determined value could be still another quantitative or qualitative term, and could for instance be binary with a zero corresponding to “misuse not likely” and a 1 corresponding to “misuse likely.” In any event, it will be appreciated that the value itself may be dependent at least in part upon the content or meaning of the data, or instead upon the entry of the data satisfying the information request, or both. “Entry” of the data may be understood as the truth or falsity of data satisfying the information request actually being successfully stored in computer readable memory. As will be further apparent from the following description, the information request may seek a variety of different types of information, and in some instances can be satisfied by data that reflects a simple Yes or No answer to a question, or instead by additional information. In some instances, the information request could be satisfied by entry of any data at all, or the lack of any data entry where an enrollee receives an information request stating, for example, “Unless told otherwise we will assume transaction X on date Y is acceptable . . . ” From the foregoing, those skilled in the art will appreciate that a great many different types of information requests, and a great many different types of information request responses, positive, negative or substantive, are contemplated herein. For that matter, it typically will not matter who is entering data in satisfaction of the information request. It might be the enrollee, a caregiver, or a computer.

Computer 12 is further configured, via execution of the code by the processor, to switch a flag setting determinative of a record obligation of the third party payor under the health plan to provide a benefit, such as pay for a product not yet delivered, to the one of the enrollees, responsive to the data. As shown in FIG. 2, database 46 may include a database record 48 for the enrollee of interest at any given time, and ultimately a plurality of database records corresponding to each one of the population of enrollees in a health plan. Database record 48 includes an enrollee ID or account number, shown as XC54, an engagement level, and a flag setting for three different prescriptions, Rx₁, Rx₂ and Rx₃. Another database record 50 stores different information queries in the form of Confirmatory, Informational, and Invasive queries, as further discussed herein. In FIG. 2, engagement level 3 is underlined to signify that the enrollee has an engagement level of 3 in the health plan, the significance of which will be further apparent from the following description.

The flag for Rx₁ is set to OFF, the flag for Rx₂ is set to OFF, and the flag for Rx₃ is set to ON. While ON and OFF could have positive or negative meanings, as desired, what is important is that each flag setting itself determines whether the third party payor is obligated under the health plan as a matter of record to provide a benefit to be delivered in the future. Each flag setting could include one bit of information at an address on computer readable memory, switched via processor 42 under appropriate circumstances as described herein. In one example, where the product delivered in the transaction is a prescription medical product such as a prescription medication, the flag for Rx₁ might be set to OFF because no refills are ever available for that particular medication. The flag setting for Rx₂ might be OFF because an allowable number of refills has been exhausted. The flag setting for Rx₃ might be set to ON because at least one refill remains.

Another way to understand what is depicted in database record 48 is that the general state of what the third party payor is obligated to pay for and what they are not obligated to pay for, as a matter of record, is stored in database 46, or can be deduced from what is stored in database 46. Accordingly, depending upon the data satisfying the information request, and typically the determined value discussed above, the record obligation of the third party payor to provide a benefit not yet delivered, such as a prescription refill, can be changed. In this general way, the enrollee's eligibility for the subject benefit is changed. If the enrollee, or someone else on behalf of the enrollee such as a caregiver, for example, provides by their action or inaction certain information (the data entered in satisfaction of the information request), and optionally if the information is considered favorably by computer 12, then the record obligation of the third party payor can be maintained or switched to ON. Where the information is not provided, or optionally where the information is considered unfavorably, then the record obligation can be turned to OFF. In this general manner, enrollees can maintain, improve, or drop in eligibility for benefits under the health plan. Rather than a simple ON-OFF scheme, of course, the third party payor's record obligation could reside on a continuum. In other words, the record obligation need not be “obligated” or “not obligated” but instead could be “not obligated,” or “obligated to provide benefit A” or “obligated to provide benefits A and B,” and so on. Rather than prescription medicine or other prescription product fills, refills and the like, the record obligation could relate to an obligation under the health plan of the third party payor to provide a discount, a rebate, a gift, or provide any of a variety of other benefits under the health plan.

This general strategy of enabling enrollee interaction to move an enrollee up or down the benefit scale is contemplated to incentivize enrollee behavior in a positive manner, and also provide a vehicle for the third party payor to avoid paying for future benefits if desired behavior is not engaged in, or the enrollee behaves in a manner undesired, such as by negatively impacting his or her health.

Also shown in FIG. 2 is client device 36a. It will be noted that device 36a has the general form of a handheld personal electronic device such as a so-called smartphone. It will therefore be appreciated that device 36a will have all the conventional and usual hardware and software attributes of a smartphone, including a display screen, a processor, memory, wireless and wired communication ports, and a camera 62. A laptop, desktop, wearable computerized device such as a wristwatch or eyewear, or any other suitable computing device might be used, however. Embodiments are also contemplated where the client device is a non-computerized device such as a land line phone. It is contemplated that certain information requests as described herein could include a request of the enrollee to photograph a medication delivered to the enrollee in a transaction of interest, using their smartphone camera, for instance. Also shown in FIG. 2 are a plurality of peripheral devices 52 configured to connect with device 36a. Peripheral devices 52 may include any of a wide variety of electronic sensing devices, and in a practical implementation strategy include a physiological state monitoring mechanism 54, such as a blood pressure cuff, equipped with a computer 55 for communicating with device 36a. Peripheral devices 52 may also include a wearable bracelet or belt device 56 also having a computer 57 and, in one embodiment, configured to sense ingestion of a medication equipped with a chip or other electronic device which is turned on, or otherwise switches its state, in response to exposure to fluids within a patient's body, breakdown or disintegration, or any other process whereby it can be detected that the medication was in fact ingested. Peripheral devices 52 may also include a fluid sensing or analysis mechanism 58, which could include a specialized vial or other receptacle which receives a body fluid such as urine, blood, or saliva, and also equipped with a computer 59 and sensing hardware to enable detection of the presence, absence, or concentration of certain compounds in the patient's body fluid. Device 58 might be used to detect the presence or absence of illicit drugs or metabolites, or the presence or absence of over-the-counter or prescribed drugs or their metabolites, in the patient's body fluids. Mechanism 58 could be a glucose monitor, for instance, or a breathalyzer. Also shown is another peripheral device 60 having the form of a scale to enable the patient's weight, and optionally also other factors as can be sensed with conventional available “scales” such as body mass index (BMI), and having a computer 61 for communicating with device 36a. Any of peripheral devices 52 could be equipped with wireless transmission hardware, or ports and wires for plugging into device 36a directly. Peripheral devices 52 may thus be capable of gathering data as to sensed parameters and digitizing the data via on-board computers for forwarding to device 36a, for use in responding to information requests as discussed herein.

In FIG. 2, device 36a is shown displaying a message querying whether the enrollee wants to view a new message from “scoring central,” in other words from computer system 12. Referring also now to FIG. 3, assuming the enrollee chooses to view the new message from scoring central, an information request displayed at stage A in FIG. 3 might be displayed querying whether a transaction for Rx₁ filled on May 1, 2014 actually occurred. The enrollee has the option to enter data in satisfaction of the displayed information request by pushing either a YES graphical button or a NO graphical button. At stage B in FIG. 3, an information request stating “please provide fluid sample” is displayed on device 36a. It can be appreciated that an enrollee can provide a fluid sample, such as by using device 58, and convey data obtained from the fluid sample back to computer system 12 by tapping the button on the display of device 36a as instructed. At stage C, device 36a is displaying an option for the enrollee to view their score. As discussed above, determining a value indicative of predicted likelihood of misuse can include calculating a score, and device 36a can also be used to enable the enrollee to view their score once calculated. Score calculation, data processing and weighting, and example strategies for determining the value indicative of predicted likelihood of misuse are further discussed below.

### INDUSTRIAL APPLICABILITY

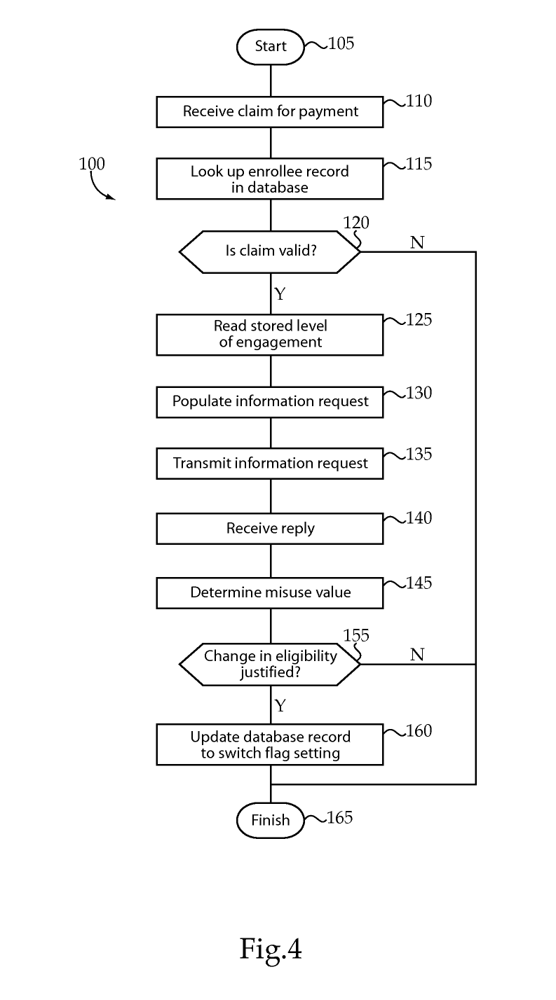

Referring to the drawings generally, but in particular now to FIG. 4, there is shown a flowchart 100 illustrating a control process including control logic executed by processor 42, according to the present disclosure. In one embodiment all steps in the process of flowchart 100 are performed by computer 12. The process of flowchart 100 commences at a START or initialize step 105, and then advances to step 110 to receive a claim for payment as described herein. From step 110, the process proceeds to step 115 to look up the record for the enrollee identified in the claim for payment, in the database. From step 115, the process may advance to step 120 to query whether the claim is valid. Step 120 might include analysis of whether refills remain for a prescription medicine, whether the enrollee's account has been flagged for fraud or doesn't exist at all, or whether any other circumstances exist that would invalidate or bring into question the claim offered for payment. From step 120, the process may advance to step 125 to read the stored level of engagement.

As discussed above, database record 48 for an enrollee can indicate whether and how the enrollee is engaged in the health plan. It is contemplated that one practical implementation strategy includes at least three different levels of contractual engagement, for instance a first level or Acknowledgement level, a second level or Informational level, and a third level or Request Action From Patient level. From step 125, the process may proceed to step 130 to populate the information request responsive to the stored level of engagement. From step 130, the process may proceed to step 135 to transmit the information request.

At engagement level 1 or the Acknowledgement level, the enrollee might receive a privacy based notification, querying whether they are aware that private medical records have been accessed. They might also be asked whether they are aware of a transaction having been executed on their account, whether they are aware that a transaction occurred at a given location, or whether they were aware of a copay being paid. The enrollee might also be asked whether they are aware that a generic for a filled prescription is available, or asked an adherence question such as whether they are using or taking their medication, or whether they have had side effects. The enrollee might also be asked whether they are aware that multiple pharmacies filled or requested payment for filling a prescription in their name and/or on their account for the same medication. It will therefore be understood that information requests to the enrollee at engagement level 1 can include any of a great many different queries, each satisfied by the enrollee entering a yes or no answer on their computer, or simply by choosing to acknowledge the information request or not. The Confirmatory query in database record 50 discussed above may be used to populate an information request at engagement level 1.

At engagement level 2, the Informational level, the enrollee might be notified by way of text message that certain actions have occurred on their account. The enrollee might be informed that medical records were checked by a pharmacy, a physician, or a hospital. The enrollee might also be informed that a pharmacy dispensed X number of tablets of medication Y, under the enrollee's health plan account. They might also be informed that a generic exists for a certain dispensed medication. The Informational query in database record 50 discussed above might be used to populate an information request at engagement level 2. It will be appreciated that messaging and notifications for an enrollee at engagement level 2 may not, or may not all be, requests for actual information as such, but the enrollee may, at his or her option, choose to make contact with the third party payor if anything appears amiss.

At engagement level 3, the enrollee might be requested to take a picture of dispensed items, or scan their dispensed items or prescription information. The patient might also be requested to connect with tracking devices for adherence or confirmation of the usage of dispensed items. The patient might also be requested to contact their doctor, pharmacist, lab or any other provider. As noted above, the patient might be requested to provide a body fluid sample, check their blood pressure, or take any of a variety of other actions. Actions requested of an enrollee at engagement level 3 may include actions dependent upon the use of peripheral devices 52, as described herein. The Invasive query in database record 50 may populate an information request at engagement level 3. All manner of electronic sensing mechanisms, functioning by way of contact with an enrollee's body or body fluids, or potentially sensing a parameter of the enrollee's physiology via proximity to the enrollee, are contemplated herein. Embodiments are contemplated where an enrollee might be asked to put on a heart rate monitor in communication with their client device or with a remote computer. Enrollees might also be requested to submit to or turn on tracking of their movements, for example. In some embodiments, an additional engagement level might be used for actions requiring access to an enrollee's body, or to the enrollee's body fluids. For instance, level 3 might require non-invasive actions such as weighing oneself, while level 4 might require more invasive actions such as body fluid sampling.

From step 135, the process may advance to step 140 to receive the reply from the enrollee, and thenceforth to step 145 to determine a value indicative of predicted likelihood of misuse, or “misuse” value. From step 145, the process may proceed to step 155 to query whether a change in eligibility is justified. If no, the process may proceed ahead to FINISH at step 165. If yes, the process may proceed to step 160 to update the database record to switch the flag setting as described herein. Determining whether a change in eligibility is justified can include comparing the determined value with a threshold value, for example, known to correspond with an empirically determined probability of misuse.

As described herein, the misuse value is predictive of a likelihood of misuse of a product, for instance, a likelihood that the enrollee will sell his medication to someone else instead of taking it, or fail to take his medication by negligence. The misuse value might also be indicative of whether a particular transaction appears to be attempted by someone other than the enrollee, in other words a fraud. In the case of an image reply, where the enrollee sends back a photo of a medication in response to an information request, the image could be compared with a stored image library of authentic medication to determine whether counterfeit medications are being provided to the enrollee. Similarity or dissimilarity between the image provided by the enrollee and an image from the stored library is quantifiable to provide the determined value by way of known techniques. Criteria for determining likelihood of misuse, and thus determining whether change in eligibility is justified could also be set arbitrarily or subjectively by an administrator of system 10.

In one further example, the misuse value might be a value determined via a scoring system, and comparison of a calculated score for an enrollee with an empirically derived benchmark score, where the determined value is a difference or is proportional to a difference between the calculated score and the benchmark score. By way of example, all enrollees might be capable of attaining a score within a predetermined range, say from 1 to 100, with a score of 1 corresponding to theoretical certainty or near certainty of misuse, and a perfect score of 100 corresponding to zero or a negligible risk of misuse and establishing the benchmark. The data entered by enrollees in satisfaction of one or more information requests can be used to establish and modify an enrollee's score, with credit or points awarded based upon the enrollee's providing of the data, and in some instances a weight accorded to data entered in response to any given information request. Embodiments are contemplated where an enrollee is awarded, say, five points for replying to information requests at engagement level 1 and, say, ten points for replying to information requests at engagement level 3. Where an enrollee acts of their own volition to contact the third party payor and correct information delivered at engagement level 2, they might be awarded twenty points. Within each engagement level, the relative value of the data entered by the enrollee can also vary based upon what type of information is at issue. For instance, within engagement level 3 an enrollee might receive ten points for providing a blood pressure reading, and twenty points for a urine sample. It is further contemplated that individual enrollees may respond to numerous information requests over time. The information requests could be tied to or initiated following particular transactions, but could also be generated independently of individual transactions. Stated another way, once enrolled in the health plan an enrollee might respond to many different queries over time, with each query having a different potential impact on their score. The queries available to be sent to any given enrollee can depend upon their level of engagement and, accordingly, information requests sent to individual enrollees can be understood to be responsive to a determined level of engagement. An enrollee at engagement level 3 could receive information requests drawn from other engagement levels, however, such as both invasive queries and confirmatory queries. It will further be appreciated that data entered in satisfaction of one information request may be weighted differently than data entered in satisfaction of another information request. Thus, an enrollee might enter data satisfying a request for acknowledgement that a generic is available at an earlier time. At a later time, the enrollee might enter data satisfying a request for the enrollee to record his heart rate. The latter data, the enrollee's heart rate, might be accorded a greater weight than the prior data.

In one example practical implementation, an enrollee's score might be initially 50, assigned by default to all enrollees in the health plan upon signing up. Compared with a benchmark score of 100, the determined value would be 50. A determined value of 50 might be considered of neutral favorability and thus not justify any change in eligibility for a benefit. Where that enrollee engages in requested actions, including reporting actions such as blood pressure, fluid samples, weight measurement, and still others, the enrollee can change their score, thus change the misuse value, and potentially accrue the right to receive benefits. By the same token that enrollee could effectively demote themselves such that they no longer have the right under the health plan to receive a benefit, such as losing the right to have a prescription refill paid for by the third party payor. One example where reducing a score and demoting might occur is where an inconsistent pattern, or a pattern otherwise abberant from a norm, of refilling prescriptions is detected. In such a case an enrollee might routinely be obtaining new prescriptions from his physician rather than using up refills for existing prescriptions. The enrollee's responses to information requests triggered via the notifications of transactions on the enrollee's account, or lack of responses, could result in losing points, reduction of the enrollee's score, and a change in the predicted likelihood of misuse. Ultimately this pattern leads to loss of the right to receive plan benefits.

The present description focuses much on the enrollee's action or inaction in compliance with requests for information, i.e. data entry. It is contemplated that calculation of scores, comparison with a benchmark score, and the overall strategy of assessing predicted likelihood of misuse, can occur without consideration of the actual content of the enrollee's replies. In other words, in many cases the interaction of the enrollee and his participation in his healthcare is believed to be more important to improving outcomes and reducing fraud, waste, and abuse, as well as managing the risk of third party payors, than is the actual meaning of the data entered by the enrollee. An example of this is where the enrollee is awarded points for reporting his blood pressure data irrespective of what his blood pressure readings actually are. The content of the data could take on more importance in certain instances, however, such as where an enrollee is being awarded points, or avoiding taking away of points, by reporting clean drug screens in urine samples, for instance. Those skilled in the art will thus appreciate that the presently disclosed strategies provide great flexibility in how scores are calculated, where benchmarks are set, and what sort of progress or lack of regress is needed to justify changing or maintaining eligibility for benefits.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A method of changing eligibility for a plan benefit of an enrollee in a health plan comprising the steps of:
receiving on a server computer system a notification of a transaction on an account of the enrollee, where a third party payor is obligated under the health plan to pay for a product delivered via the transaction;
transmitting an information request from the server computer system to a client device of the enrollee;
receiving on the server computer system data entered in satisfaction of the information request; and
switching a flag setting via the processor, responsive to the data, and being determinative of a record obligation of the third party payor under the health plan to provide a plan benefit not yet delivered to the enrollee.

2. The method of claim 1 wherein the delivered product includes an original fill of a prescription medical product, and the plan benefit not yet delivered includes a payment for a refill of the prescription medical product.

3. The method of claim 2 wherein the step of receiving a notification includes receiving an electronic claim for payment by the third party payor for the original fill.

4. The method of claim 3 further comprising a step of authorizing the claim for payment on the server computer system, and wherein the step of transmitting further includes transmitting the information request, responsive to the authorization.

5. The method of claim 1 wherein the step of receiving data further includes receiving data transmitted from the client device of the enrollee to the server computer system.

6. The method of claim 4 wherein the step of receiving data further includes receiving data gathered via an electronic sensing mechanism in communication with the client device.

7. The method of claim 5 wherein the step of receiving data further includes receiving data gathered via contact between the electronic sensing mechanism and the enrollee's body or a body fluid of the enrollee.

8. The method of claim 1 further comprising a step of calculating a score for the enrollee based at least in part on the data, and wherein the step of switching further includes switching the flag setting responsive to the calculated score.

9. The method of claim 8 further comprising the steps of comparing the calculated score with a benchmark score, and determining a value indicative of predicted likelihood of misuse of the delivered product based on a difference between the calculated score and the benchmark score, and wherein the step of switching includes switching the flag setting responsive to the determined value.

10. The method of claim 8 wherein the step of calculating further includes calculating the score based in part upon the data and in part upon previous data received on the server computer system and entered in satisfaction of a prior information request.

11. The method of claim 10 wherein the step of calculating further includes a step of weighting the data entered in satisfaction of the first information request differently from the data entered in satisfaction of the prior information request.

12. The method of claim 1 further comprising a step of populating the information request with an information query selected from a stored catalog of information queries.

13. The method of claim 12 further comprising the steps of determining from a stored database record for the enrollee a level of engagement of the enrollee in the health plan, and selecting the information query responsive to the level of engagement.

14. A system for benefits administration in a health plan comprising:
a server computer including a processor, a computer readable memory coupled with the processor, and inputs and outputs for receiving and transmitting data between the server computer and a communications network;
the computer readable memory storing a control algorithm, in code executable by the processor, for changing eligibility for plan benefits of any one of a population of enrollees in the health plan;
the server computer being configured to receive a notification transmitted over the communications network and being indicative of a transaction on an account of one of the enrollees, where a third party payor is obligated under the health plan to pay for a product delivered in the transaction;
the server computer being further configured to transmit an information request over the communications network to a client device of the one of the enrollees, and to receive and store data entered in satisfaction of the information request; and
the server computer being further configured, via execution of the code by the processor, to switch a flag setting determinative of a record obligation of the third party payor under the health plan to provide a plan benefit not yet delivered to the one of the enrollees, responsive to the data.

15. The system of claim 14 further comprising a plurality of electronic sensing mechanisms each configured to communicate with a client device of one of the enrollees, and to gather the data via contact with the enrollee's body or body fluid.

16. The system of claim 14 wherein the computer readable memory stores a catalog of information queries, and the server computer is further configured to populate the information request with a selected one of the information queries.

17. The system of claim 16 wherein the server computer is further configured to read, from a database record for the one of the enrollees, an engagement level of the one of the enrollees in the health plan, and to select the information query responsive to the engagement level.

18. The system of claim 14 wherein the server computer is further configured to calculate a score for the enrollee based at least in part on the data, to compare the calculated score with a benchmark score, and to switch the flag setting responsive to a difference between the calculated score and the benchmark score.

19. The system of claim 18 wherein the server computer is further configured to calculate the score based in part upon the data and in part upon previous data received on the computer server and entered in satisfaction of a prior information request.

20. The system of claim 19 wherein the server computer is further configured to weight the data entered in satisfaction of the first information request differently from the data entered in satisfaction of the prior information request.
